(19) United States
(12) Patent Application Publication
(10) Pub. No.: US 2017/0341733 A1
(43) Pub. Date: Nov. 30, 2017

(54) ROTOR HEAD FOR PROP-ROTOR

(71) Applicant: Sikorsky Aircraft Corporation, Stratford, CT (US)

(72) Inventors: Frank P. D'Anna, Seymour, CT (US); Timothy Fred Lauder, Oxford, CT (US); Mark R. Alber, Milford, CT (US); Irving Lawrence Cullen, North Haven, CT (US); Bryan Kenneth Baskin, Arlington, TX (US)

(21) Appl. No.: 15/467,811

(22) Filed: Mar. 23, 2017

Related U.S. Application Data
(60) Provisional application No. 62/342,262, filed on May 27, 2016.

(51) Int. Cl. B64C 11/34; B64C 27/605; B64C 27/10; B64C 27/82; B64C 29/00; B64C 29/02

(52) U.S. Cl. CPC B64C 11/34; B64C 29/0033; B64C 29/02; B64C 27/10; B64C 27/82; B64C 27/605; B64C 2027/8236

(57) ABSTRACT

A rotor head is provided and includes a non-rotating frame, a rotating frame rotatable relative to the non-rotating frame and configured to impart motion to the rotating frame, a rotor hub assembly rotatable about a rotation axis and including a hub and blades extending outwardly from the hub and being pivotable about respective pitch axes thereof and rocker assemblies respectively associated with corresponding ones of the blades. Each rocker assembly is interconnected between the rotating frame and the corresponding one of the blades and configured to convert the motion imparted to the rotating frame into a pitching of one of the blades about the respective pitch axes and amplify the motion such that an angle of the pitching exceeds an angle that would be achieved if the corresponding one of the blades were connected directly to the rotating frame.

### CROSS-REFERENCE TO RELATED APPLICATION

This application claims benefit of priority of U.S. Provisional Application No. 62/342,262 filed on May 27, 2016, the disclosure of which is incorporated by reference.

### STATEMENT REGARDING FEDERALLY SPONSORED RESEARCH OR DEVELOPMENT

This invention was made with Government support under HR0011-14-C-0010 awarded by DARPA. The Government has certain rights in this invention.

### BACKGROUND OF THE DISCLOSURE

The subject matter disclosed herein relates to a rotor head for a prop-rotor and, more particularly, to a rotor head for a prop-rotor having a rocker arm that amplifies control motion.

Rotor heads generally include a rotating shaft, a hub and blades extending outwardly from the hub. Rotation of the rotating shaft drives corresponding rotation of the hub and the blades such that the blades rotate about a rotational axis defined along the rotating shaft. A swashplate apparatus, including a non-rotating swashplate and a rotating swashplate, may be disposed about the rotating shaft to provide for collective and cyclic control of the blades during rotation. Such controls cause the blades to collectively and/or cyclically pitch about their respect pitch axes and to allow for increased or decreased thrust and for directional control of thrust vectoring.

As numbers of blades of a given rotor head increases, the ability to control the pitching of each of the blades becomes increasingly difficult. This is due to the fact that the increased numbers of blades leads to a decrease in the space available for pitch control elements. Within this regime, if pitch control elements are resized to fit into the rotor head, the rotor head may not be able to meet requirements for blade pitch control. By contrast, if the rotor head as a whole is resized, the increase in weight and drag leads to other negative consequences.

### BRIEF DESCRIPTION OF THE DISCLOSURE

According to one aspect of the disclosure, a rotor head is provided and includes a non-rotating frame, a rotating frame rotatable relative to the non-rotating frame and configured to impart motion to the rotating frame, a rotor hub assembly rotatable about a rotation axis and including a hub and blades extending outwardly from the hub and being pivotable about respective pitch axes thereof and rocker assemblies respectively associated with corresponding ones of the blades. Each rocker assembly is interconnected between the rotating frame and the corresponding one of the blades and configured to convert the motion imparted to the rotating frame into a pitching of the corresponding one of the blades about the respective pitch axes and amplify the motion imparted to the rotating frame such that an angle of the pitching of the corresponding one of the blades exceeds an angle of the pitching that would be achieved if the corresponding one of the blades were connected directly to the rotating frame.

In accordance with additional or alternative embodiments, the rotor hub assembly includes a stiff in-plane rotor.

In accordance with additional or alternative embodiments, the rotor hub assembly includes five blades.

In accordance with additional or alternative embodiments, the hub includes a dynamic droop stop.

In accordance with additional or alternative embodiments, the hub includes an indented cap.

In accordance with additional or alternative embodiments, the rocker assembly includes a support member affixed to the hub, a rocker arm, which is supportable on the support member to be pivotable about a rocker arm pivot axis and which includes short and long sides on opposite sides of the rocker arm pivot axis, a control rod disposed for respective rotatable connections to the rotating frame and the short side and a pitch link disposed for respective rotatable connections to a pitch horn of the corresponding one of the blades and the long side.

In accordance with additional or alternative embodiments, the control rod is longer than the pitch link.

In accordance with additional or alternative embodiments, the control rod is adjustable.

In accordance with additional or alternative embodiments, the control rod is connectable with a distal end of the short side, the pitch link is connectable to a distal end of the long side and the long side is longer than the short side as measured along respective longitudinal axes thereof from the pivot axis.

According to another aspect of the disclosure, a tail sitter aircraft is provided and includes a fuselage, wings extending outwardly from opposite sides of the fuselage and at least one of prop-rotors operably disposed on the fuselage and prop-rotors operably disposed along each of the wings to generate lift during vertical take-off and landing operations and to generate thrust during horizontal flight operations. At least one of the prop-rotors includes the rotor head described above.

In accordance with additional or alternative embodiments, the prop-rotors are provided in a rotor-blown wing configuration.

According to another aspect of the disclosure, an aircraft is provided and includes an airframe having an upper portion and a tail and main and tail rotor assemblies respectively disposed at the upper portion and the tail of the airframe. At least one of the main or tail rotor assemblies includes the rotor head described above.

In accordance with additional or alternative embodiments, the main rotor assembly includes coaxial, counter rotating rotors and the tail rotor assembly includes a pusher propeller.

According to yet another aspect of the disclosure, a rotor head is provided and includes a hub, blades extending outwardly from the hub and being pivotable about respective pitch axes thereof, a servo operably disposed to drive a pitching of each of the blades and rocker assemblies respectively associated with corresponding ones of the blades. Each rocker assembly is configured to generate a pitch stroke for the corresponding one of the blades which is longer than a stroke of the servo.

In accordance with additional or alternative embodiments, the blades are provided in a five blade array.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a rotor head for a prop-rotor in accordance with embodiments;

FIG. 2 is a side view of the rotor head of FIG. 1;

FIG. 3 is a perspective view of a rocker assembly of the rotor head of FIG. 1;

FIG. 4 is a schematic illustration of a five-sided array of rocker assemblies in accordance with embodiments;

FIG. 5 is a schematic illustration of a servo control and the rocker assembly of FIG. 3 in accordance with embodiments;

FIG. 6 is a side view of a portion of a hub of the rotor head of FIG. 1 in accordance with embodiments;

FIG. 7 is a top-down view of a portion of a hub of the rotor head of FIG. 1 in accordance with embodiments;

FIG. 8 is an elevation view of a tail sitter aircraft in accordance with embodiments;

FIG. 9 is a perspective view of an exemplary coaxial, counter-rotating helicopter in accordance with non-limiting embodiments; and

FIG. 10 is a perspective view of a tiltrotor or tiltwing in accordance with embodiments.

The detailed description explains embodiments of the disclosure, together with advantages and features, by way of example with reference to the drawings.

### DETAILED DESCRIPTION OF THE DISCLOSURE

As will be described below, a prop-rotor is provided with a number of blades (e.g., five blades or any of number blades from three to six or more) and a compact envelop for blade retention and control systems that maintain required stability capabilities. The prop-rotor is capable of providing for cyclical feathering motion, which can be referred to as “delta-3” in shorthand, in order to produce pitch-flap coupling that decreases blade pitch and angle of attack when a blade flaps upwardly. The prop-rotor includes a rocker arm to amplify control motions by way of a small radius on the swashplate side via a connection between the rocker arm and the swashplate along a long control rod and a larger radius on the horn side via a connection between the rocker arm and the pitch horn along a short pitch link. Particularly, the uneven ratio of the radii amplifies swashplate motion such that pitch motion of the blades meets the requirements of the prop-rotor. The configuration solves the problem of locating control rods for blade pitch controls in advantageous positions for stability while maintaining adequate clearances between the control rods and the hub and the adjacent blades. The configuration also enables the use of a servo with a stroke that is shorter than the vertical travel of the pitch control link.

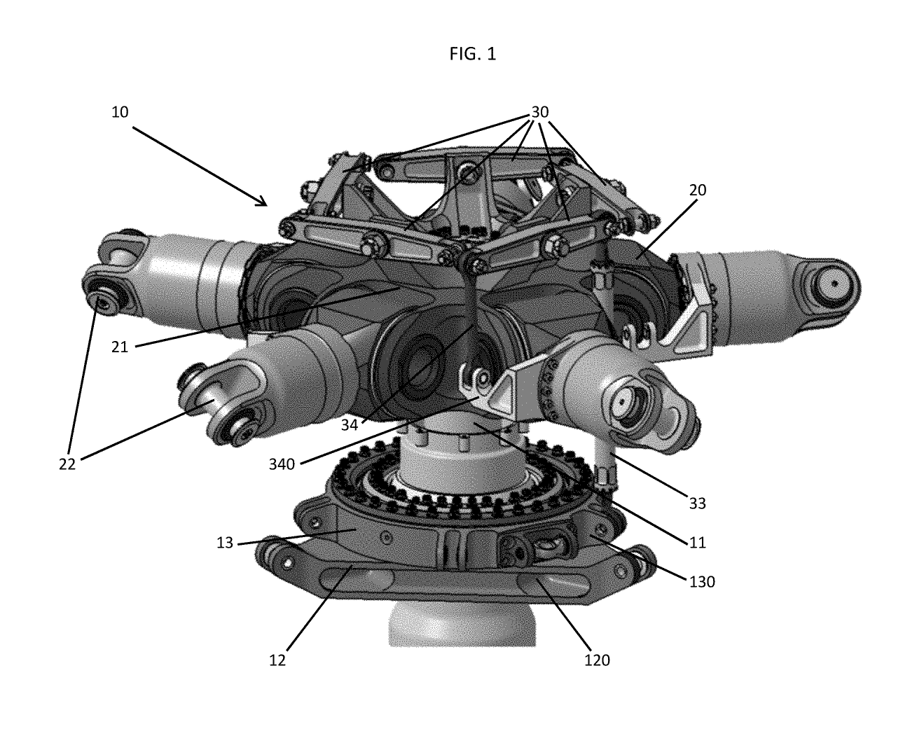

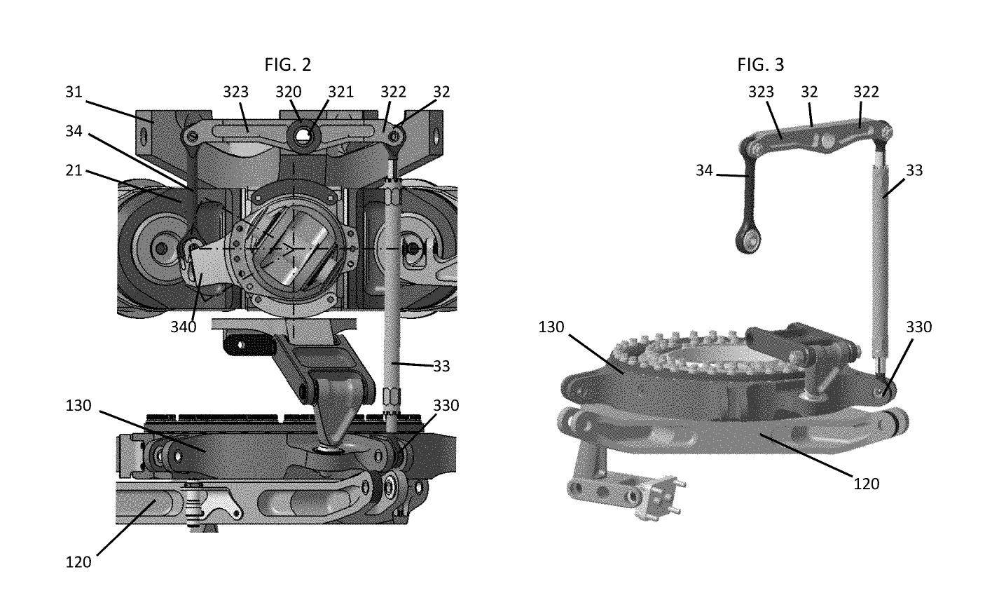

With reference to FIGS. 1-3, 9 and 10, a rotor head 10 is provided. The rotor head 10 includes a rotating shaft 11, a non-rotating frame 12 that is disposed about the rotating shaft 11 and can tilt and translate relative to the rotating shaft 11 and a rotating frame 13. The rotating frame 13 is rotatable relative to the non-rotating frame 12. The non-rotating frame 12 may be provided as a non-rotating swashplate 120 and the rotating frame 13 may be provided as a rotating swashplate 130. The rotor head 10 further includes a rotor hub assembly 20 and rocker assemblies 30. The rotor hub assembly 20 includes a hub 21, which is attachable to the rotating shaft 11, and blades 22 (see, e.g., FIGS. 9 and 10 as FIG. 1 shows only inboard ends of blades 22). The blades 22 extend radially outwardly from the hub 21 and are pivotable about respective pitch axes thereof. During operations of the rotor head 10, rotation of the rotating shaft 11 is transmitted to the hub 21 and from the hub 21 to each of the blades 22. The blades 22 thus rotate about a rotational axis defined along the rotating shaft 11 to generate lift (and, in some cases, thrust) by aerodynamic interactions of the blades 22 with surrounding air.

In accordance with embodiments, five blades 22 may be provided for the rotor head 10. Each of the five blades 22 may be uniformly distant from its adjacent neighbor blades. Of course, it is to be understood that the description provided herein can be applied to rotor heads with greater or lesser numbers of blades as well. For example, the number of blades 22 may be three to six or more.

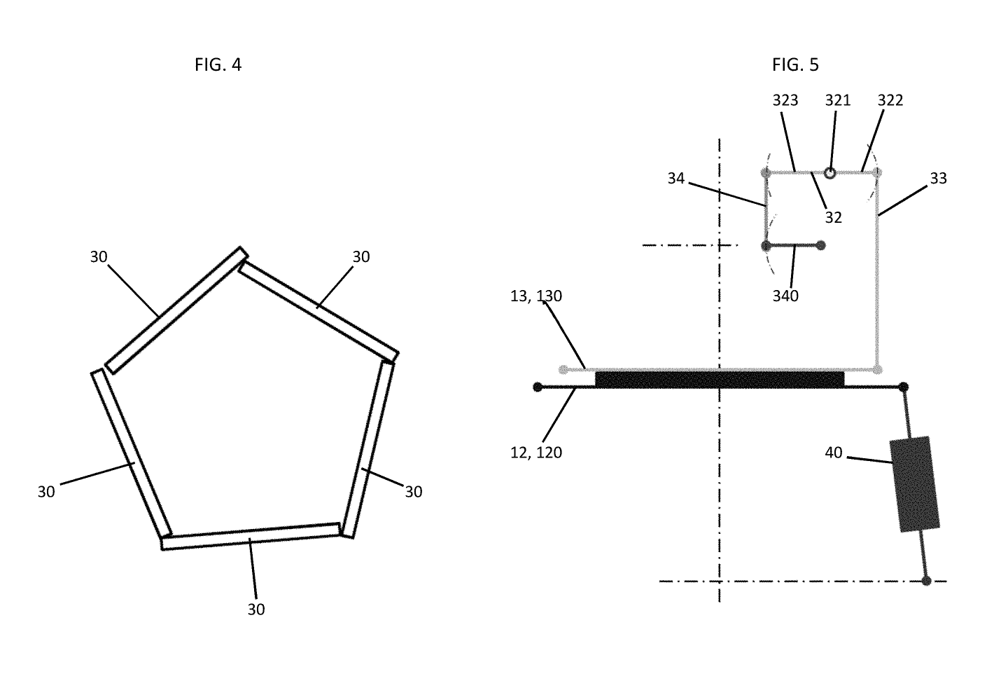

The rocker assemblies 30 are respectively associated with corresponding ones of the blades 22. Thus, if there are five blades 22, the rotor head 10 will include five rocker assemblies 30. Each rocker assembly 30 is interconnected between the rotating frame 13 and the corresponding one of the blades 22 and is configured to convert translation and tilting motion of the rotating frame 13 into a pitching of the corresponding one of the blades 22. Each rocker assembly 30 is further configured to amplify the translation and tilting motion of the rotating frame 13 such that an angle of the pitching of the corresponding one of the blades 22 exceeds an angle of the pitching that would be achieved if the blade 22 (or, where applicable, the pitch horn) were connected directly to the rotating frame 13 through a single control rod. With reference to FIG. 4, the rocker assemblies 30 may be provided in a star-like shape in which, when seen from above, each rocker assembly 30 extends from outside a first neighboring rocker assembly 30 and terminates inside a second neighboring rocker assembly 30.

In accordance with embodiments, the rotor head 10 may be provided as a stiff in-plane rotor head in that the blades 22 are restricted from exhibiting lead-lag during rotation of the rotating shaft 11. However, it is to be understood that this is not required and that the description provided herein applies to other types of rotor heads as well.

The rocker assembly 30 includes, for each blade 22, a support member 31 that is affixed to an upper portion of the hub 21, a rocker arm 32, a control rod 33 and a pitch link 34. The rocker arm 32 is supportable on the support member 31 above the blades 22 by a pin-type connection 320 such that the rocker arm 32 is pivotable about a pivot axis 321 defined through the pin-type connection 320. The rocker arm 32 includes a short side elongate member 322 on a first side of the pivot axis 321 and a long side elongate member 323 on a second side of the pivot axis 321 opposite the first side. The short side elongate member 322 and the long side elongate member 323 each have respective distal ends with the long side elongate member 323 having a longer length as measured along a longitudinal axis thereof from the pivot axis 321 to its distal end than a length of the short side elongate member 322 as measured along a longitudinal axis thereof from the pivot axis 321 to its distal end.

The control rod 33 is disposable to be rotatably connected to a lug 330 that is affixed to a side of the rotating swashplate 130 and to be rotatably connected to the distal end of the short side elongate member 322. The pitch link 34 is disposable to be rotatably connected to a pitch horn 340 of a corresponding one of the blades 22 and the distal end of the long side elongate member 323. The control rod 33 may be provided as an adjustable pitch control rod, such that its axial length is extendable and retractable, but is in any event longer than the pitch link 34.

With reference to FIG. 5 and, with the configuration described above, a relatively small motion of the rotating swashplate 130 may be generated or caused by actuation of a servo control element 40, which is coupled to the non-rotating swashplate 120. Such relatively small motion of the rotating swashplate 130 corresponds to a similarly small vertical movement (or horizontal movement if the rotor is in the propeller mode of operation) of the control rod 33 as well as a small-radius-pivot of the short side elongate member 322 on the first side of the pivot axis 321. This small-radius-pivot of the short side elongate member 322 results in a large-radius-pivot of the long side elongate member 323 on the second side of the pivot axis 321. The large-radius-pivot of the long side elongate member 323 is transmitted to the pitch horn 340 of the corresponding one of the blades 22 such that the blade 22 pivots about its pitch axis. Thus, due to the uneven ratio of the rocker arm 32 relative to the pivot axis 321 leading to the large-radius-pivot of the long side elongate member 323 as compared to the small-radius-pivot of the short side elongate member 322, a pivoting angle of the blade 22 may be larger than a pivoting angle that would be achieved if the pitch horn were connected directly to the rotating swashplate 130. That is, the configuration enables the use of the servo control element 40 with a stroke that is shorter than the vertical travel of the pitch link 34.

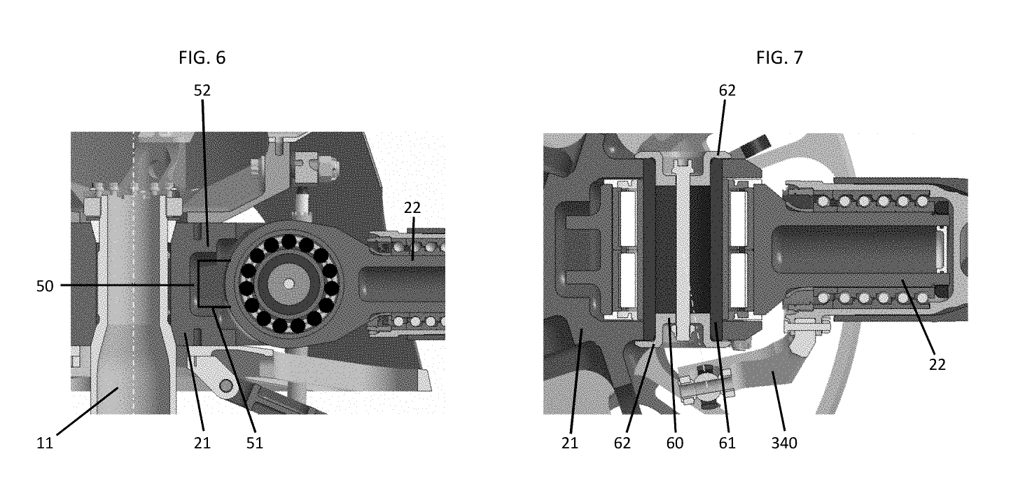

In accordance with further embodiments and, with reference to FIGS. 6 and 7, the hub 21 may include a dynamic droop stop element 50 (see FIG. 6) and an indented cap element 60 (see FIG. 7). As shown in FIG. 6, the dynamic droop stop element 50 is provided as a boss 51 extending radially inwardly along the pitch axis of the corresponding one of the blades 22 and upper and lower mechanical stoppers 52. The upper and lower mechanical stoppers 52 may be affixed to the hub 21 and serve to prevent coning or drooping of the blade 22 by mechanical interference with the boss 51. As shown in FIG. 7, the indented cap element 60 contains a flap pin 61 with opposite longitudinal ends 62 that are recessed from opposite sides of the hub proximate to the blade 22 such that additional room is provided for the pitch horn 340, for example.

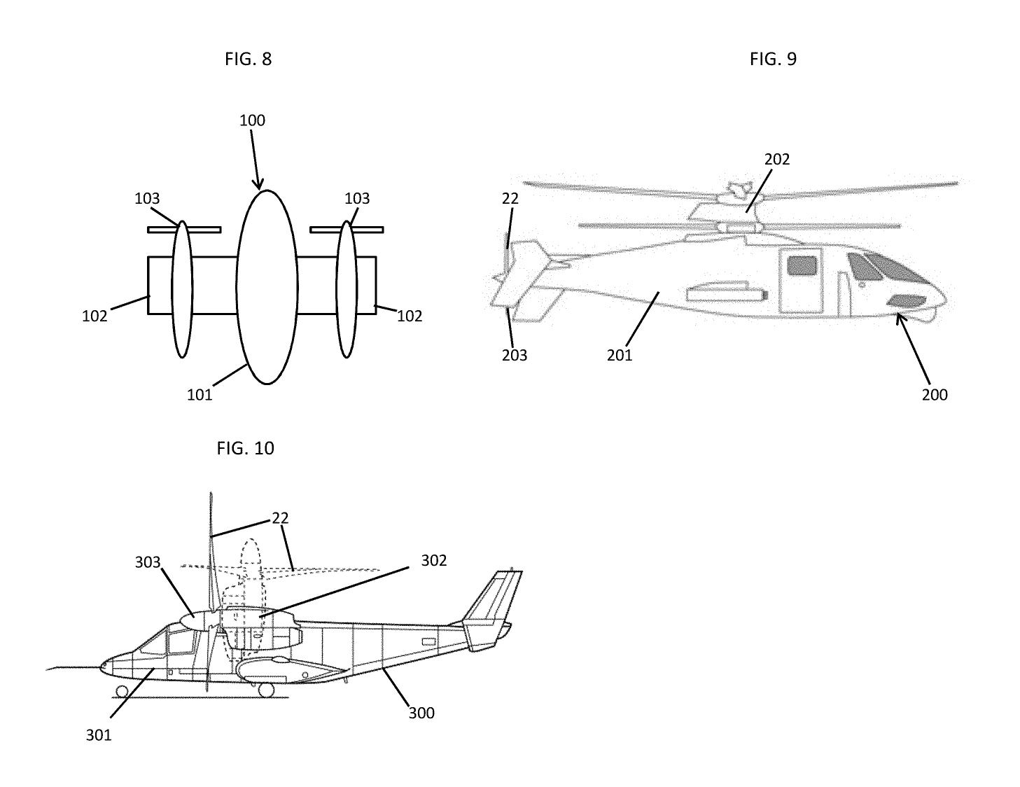

With reference to FIG. 8, a vertical take-off and landing (VTOL) tail sitter aircraft 100 is provided and includes a fuselage 101, wings 102 that extend outwardly from opposite sides of the fuselage 101 and prop-rotors 103. The prop-rotors 103 may be disposed on leading or tailing ends of the fuselage 101 and/or may be disposed along each of the wings 102 in a rotor-blow wing (RBW) configuration (see FIG. 8) where the prop-rotors 103 lead the wings 102 or a configuration in which the wings 102 lead the prop-rotors 103. In any case, the prop-rotors 103 generate lift during vertical take-off and landing operations for the tail-sitter aircraft 100 and generate thrust during horizontal flight operations thereof. Moreover, at least one of the prop-rotors 103 may be provided as or may include the rotor head 10 described above.

With reference to FIG. 9, an aircraft 200 is provided and may be configured as a helicopter or as any rotorcraft such as a tail sitter. The aircraft 200 may for example include an airframe 201 having an upper portion and a tail, a main rotor assembly 202 at the upper portion of the airframe 201 and a tail rotor assembly 203 at the tail of the airframe 201. In accordance with non-limiting embodiments and, as shown in FIG. 9, the aircraft 200 may be configured as a compound helicopter with the main rotor assembly 202 being provided as coaxial, counter-rotating upper and lower rotors and the tail rotor assembly 203 being provided as a pusher-propeller. Of course, it is to be understood that other aircraft configurations, such as those of a conventional helicopter and a tail-sitter may apply as well. In any case, at least one of the main rotor assembly 202 and the tail rotor assembly 203 may be provided as or may include the rotor head 10 described above.

With reference to FIG. 10, a vertical take-off and landing (VTOL) tiltrotor aircraft 300 is provided and includes a fuselage 301, wings 302 that extend outwardly from opposite sides of the fuselage 301 and prop-rotors 303. The prop-rotors 303 may be disposed in fixed or tilting nacelles at the ends of wings 302 and wings 302 may or may not tilt relative to fuselage 301 in the case of a tilt-wing configuration. The prop-rotors 303 generate lift during vertical take-off and landing operations for the aircraft 300 and generate thrust during horizontal flight operations thereof. Moreover, at least one of the prop-rotors 303 may be provided as or may include the rotor head 10 described above. In some configurations, the aircraft 300 may have more than one wing 302 attached to fuselage 301 and each wing 302 may mount prop-rotors 303 as previously described.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A rotor head, comprising:
a non-rotating frame;
a rotating frame rotatable relative to the non-rotating frame and configured to impart motion to the rotating frame;
a rotor hub assembly rotatable about a rotation axis and comprising a hub and blades extending outwardly from the hub and being pivotable about respective pitch axes thereof; and
rocker assemblies respectively associated with corresponding ones of the blades, each rocker assembly being interconnected between the rotating frame and the corresponding one of the blades and configured to:
convert the motion imparted to the rotating frame into a pitching of the corresponding one of the blades about the respective pitch axes, and
amplify the motion imparted to the rotating frame such that an angle of the pitching of the corresponding one of the blades exceeds an angle of the pitching that would be achieved if the corresponding one of the blades were connected directly to the rotating frame.

2. The rotor head according to claim 1, wherein the rotor hub assembly comprises a stiff in-plane rotor.

3. The rotor head according to claim 1, wherein the rotor hub assembly comprises five blades.

4. The rotor head according to claim 1, wherein the hub comprises a dynamic droop stop.

5. The rotor head according to claim 1, wherein the hub comprises an indented cap.

6. The rotor head according to claim 1, wherein each of the rocker assembly comprises:
a support member affixed to the hub;
a rocker arm, which is supportable on the support member to be pivotable about a rocker arm pivot axis and which comprises short and long sides on opposite sides of the rocker arm pivot axis;
a control rod disposed for respective rotatable connections to the rotating frame and the short side; and
a pitch link disposed for respective rotatable connections to a pitch horn of the corresponding one of the blades and the long side.

7. The rotor head according to claim 6, wherein the control rod is longer than the pitch link.

8. The rotor head according to claim 7, wherein the control rod is adjustable.

9. The rotor head according to claim 6, wherein:
the control rod is connectable with a distal end of the short side of the rocker,
the pitch link is connectable to a distal end of the long side of the rocker, and
the long side is longer than the short side as measured along respective longitudinal axes thereof from the pivot axis.

10. A tail sitter aircraft, comprising:
a fuselage;
wings extending outwardly from opposite sides of the fuselage; and
at least one of prop-rotors operably disposed on the fuselage and prop-rotors operably disposed along each of the wings to generate lift during vertical take-off and landing operations and to generate thrust during horizontal flight operations,
at least one of the prop-rotors comprising the rotor head of claim 1.

11. The tail sitter aircraft according to claim 10, wherein the prop-rotors are provided in a rotor-blown wing configuration.

12. An aircraft, comprising:
an airframe having an upper portion and a tail; and
main and tail rotor assemblies respectively disposed at the upper portion and the tail of the airframe,
at least one of the main and tail rotor assemblies comprising the rotor head of claim 1.

13. The aircraft according to claim 12, wherein the main rotor assembly comprises coaxial, counter rotating rotors and the tail rotor assembly comprises a pusher propeller.

14. A rotor head, comprising:
a hub;
blades extending outwardly from the hub and being pivotable about respective pitch axes thereof;
a servo operably disposed to drive a pitching of each of the blades; and
rocker assemblies respectively associated with corresponding ones of the blades, each rocker assembly being configured to generate a pitch stroke for the corresponding one of the blades which is longer than a stroke of the servo.

15. The rotor head according to claim 14, wherein the blades are provided in a five blade array.
